(19) United States
(12) Patent Application Publication
(10) Pub. No.: US 2015/0192552 A1
(43) Pub. Date: Jul. 9, 2015

(54) DETECTOR FOR NITRO-CONTAINING COMPOUNDS COMPRISING FUNCTIONALIZED SILICON NANOCRYSTALS AND METHODS OF USE THEREOF

(71) Applicants: Jonathan G. C. Veinot, Edmonton (CA); Mita Dasog, Edmonton (CA); Christina Gonzalez, Edmonton (CA); Muhammed Iqbal, Edmonton (CA); Tapas Purkait, Edmonton (CA); Reid Erickson, Edmonton (CA)

(72) Inventors: Jonathan G. C. Veinot, Edmonton (CA); Mita Dasog, Edmonton (CA); Christina Gonzalez, Edmonton (CA); Muhammed Iqbal, Edmonton (CA); Tapas Purkait, Edmonton (CA); Reid Erickson, Edmonton (CA)

(73) Assignee: THE GOVERNORS OF THE UNIVERSITY OF ALBERTA, Edmonton (CA)

(21) Appl. No.: 14/580,265

(22) Filed: Dec. 23, 2014

Related U.S. Application Data
(60) Provisional application No. 61/923,255, filed on Jan. 3, 2014.

(51) Int. Cl. G01N 31/22

(52) U.S. Cl. CPC G01N 31/22

(57) ABSTRACT

A detector and a method for the detection of nitro-containing compounds, such as explosives, is described. Detection is by observing the quenching of the photoluminescence of functionalized silicon nanocrystals, such as amine-functionalized silicon nanocrystals, oligonucleotide-functionalized silicon nanocrystals, oligomer or monolayer alkyl-functionalized silicon nanocrystals, aromatic polymer-functionalized silicon nanocrystals and alkanoic acid-functionalized silicon nanocrystals by the nitro-containing compounds. The detector and method are non-toxic, portable, rapid and straightforward and therefore are amenable for convenient on-site detection of nitro-containing compounds.

### CROSS-REFERENCE TO RELATED APPLICATIONS

The present application claims the benefit of priority from co-pending U.S. provisional application No. 61/923,255 filed on Jan. 3, 2014, the contents of which are incorporated herein by reference in their entirety.

### FIELD

The present application relates to a detector that can be used to identify nitro-containing compounds and to methods of use thereof. In particular, the detector of the present application comprises functionalized silicon nanocrystals and contact of the nitro-containing compounds with the functionalized silicon nanocrystals results in a detectable reduction in the luminescence of the nanocrystals.

### BACKGROUND

Of late, sensing high energy materials (i.e., explosives) has received substantial attention because of the obvious importance to security and forensics; detection of these materials is also crucial because many are toxic and pose environmental risks.^{1,2,3} Modern methods for detecting explosives include gas chromatography coupled with mass spectrometry, ion mobility spectrometry, surface enhanced Raman spectroscopy, and energy dispersive X-ray spectroscopy.^{4,5,6,7} Unfortunately, all of the methods listed here are infrastructure intensive and cannot be readily implemented in the field or outside a laboratory setting.⁸ In this context, development of techniques for straightforward, rapid, on-site detection is of paramount importance.

An attractive approach toward realizing this goal is the development of fluorescent sensors that respond to these compounds. These sensors are usually comparatively simple, require minimal infrastructure, are cost effective and exhibit adequate sensitivity and response times.⁹ Recently, luminescent nanomaterials (e.g., Cd-based quantum dots) have been explored as fluorescent sensors (QDs) because their exquisite tunability.^{10,11,12} Freeman and coworkers successfully employed fluorescent, functionalized CdSe/ZnS QDs to detect trace quantities of trinitrotoluene (TNT) and cyclotrimethylenetrinitramine (RDX).¹³ In efforts to render these systems portable and increase their compatibility with field applications, researchers interfaced the active nanomaterials with common filter paper to afford a detection system. Zhang and coworkers coated filter paper with dual-emission CdTe quantum dots that luminesce different colours in the presence of TNT.¹⁴ Similarly, Ma and coworkers used the molecular emitter 8-hydroxyquinoline aluminum and nanospheres to detect 2,4,6-trinitrophenol.¹⁵

Quantum dots have the clear advantage over molecule-based emitters that they do not photobleach, however CdSe and CdTe quantum dots are toxic. Regulations exist or are pending in numerous jurisdictions that limit their widespread use in industrial and consumer applications—new materials must be explored.¹⁶ Silicon nanocrystals (SiNCs) are an attractive alternative material that maintains all the advantages of quantum dots (e.g., tailorability and photostability) with the clear benefit of being non-toxic. Content and coworkers showed the photoluminescence of hydride terminated porous silicon films was quenched upon exposure to dinitrotoluene (DNT), TNT, and nitrobenzene (NB) vapors. These quenching processes are believed to occur via a reversible electron transfer mechanism or irreversible chemical oxidation depending on the duration of vapor exposure.¹⁷ However, hydride surface terminated porous silicon is readily oxidized upon exposure to air and is fragile, making it impractical for field applications. Germanenko and coworkers demonstrated the red luminescence of web-like agglomerated silicon nanocrystals (d˜5-6 nm) bearing a 1-2 nm oxide surface layer was quenched when exposed to nitroaromatic compounds.¹⁸ Unfortunately the luminescence of these materials was not affected by explosives-related compounds NB and mononitrotoluene (MNT) that are common degradation products of nitro class explosives typically found in landmines.¹⁹

### SUMMARY

In the present application, a series of nitroaromatic compounds (i.e., mononitrotoluene (MNT), nitrobenzene (NB), dinitrotoluene (DNT), and trinitrotoluene (TNT)), as well as the nitroamine cyclotrimethylenetrinitramine (also known as Research Department Explosive or RDX) and nitrate ester pentaerythritol tetranitrate (PETN) were detected by exploiting the optical response of non-toxic functionalized silicon nanocrystals in solution. Further, in the present application, the fabrication and application of an air stable photoluminescent paper detector based upon the non-toxic surface functionalized silicon nanocrystals was achieved. This paper-based system showed rapid detection of nitroaomatics, nitroalkanes, and nitrate esters by luminescent quenching in solution as well as solid phase at nanogram levels.

Accordingly, the present application includes a detector for nitro-containing compounds comprising functionalized silicon nanocrystals (SiNCs) supported on a substrate.

In an embodiment, the functionalized SiNCs are alkyl-, alkanoic acid-, amine-, oligonucleotide- or aromatic polymer-functionalized SiNCs. In a further embodiment, the functionalized SiNCs are selected from oligomer C₄-C₂₄alkyl-functionalized SiNCs, monolayer C₄-C₂₄alkyl-functionalized SiNCs, polystyrene-functionalized SiNCs and C₁-C₁₀alkanoic acid-functionalized SiNCs.

The present application also includes a method for detecting the presence of nitro-containing compounds in a sample comprising:

(a) exposing functionalized SiNCs to a sample suspected of comprising one or more nitro-containing compounds;
(b) observing the photoluminescence of the functionalized SiNCs in the presence and absence of the sample;
wherein a decrease in the photoluminescence of the functionalized SiNCs in the presence of the sample compared to the photoluminescence in the absence of the sample indicates the presence of nitro-containing compounds in the sample.

The present application also includes a use of functionalized SiNCs to detect nitro-containing compounds.

### BRIEF DESCRIPTION OF THE DRAWINGS

Further details for the present application will be made with referenced to the attached drawings in which:

FIG. 1 shows the characterization of oligomer dodecyl functionalized SiNCs as an exemplary embodiment of the present application: (A) FTIR spectrum (B) Fluorescence spectrum (C) TEM image of resulting nanocrystals and (D) the particle size distribution analysis.

FIG. 2 shows the FTIR characterization of monolayer dodecyl-, polystyrene-, and pentanoic acid-functionalized SiNCs as further exemplary embodiments of the present application.

FIG. 3 shows the fluorescence spectrum of monolayer dodecyl-, polystyrene-, and pentanoic acid-functionalized SiNCs as further exemplary embodiments of the present application.

FIG. 4 shows (A) Fluorescence quenching spectra of SiNCs by increasing concentrations of DNT in solution with an inset showing the quenching effect with 0 and 25 mM DNT atop bench-top UV-lamp. (B) and (D) The Stern-Volmer plots for the quenching efficiencies and PL lifetimes of NB, MNT and DNT at different concentrations. (C) The PL lifetime decays of SiNCs with increasing concentrations of DNT.

FIG. 5 shows a schematic representation of the preparation and use of SiNC sensor paper in one embodiment of the present application. (1) A piece of filter paper is dip coated in a solution of concentrated SiNCs, (2) the resulting paper is fluorescent under UV light, (3) nitroaromatic solution is spotted onto the sensing paper, (4) quenching of the spot is observed under UV light.

FIG. 6 shows concentration spot tests of nitroaromatics NB, MNT, and DNT at concentrations of 0.25, 5 and 25 mM of each compound on filter paper impregnated with exemplary fluorescent oligomer dodecyl-functionalized SiNCs of the present application.

FIG. 7 shows images of oligomer dodecyl-functionalized SiNC coated filter paper under a handheld UV-lamp (A) without the presence of nitro compound and in the presence of solutions of (B) TNT, (C) RDX, (D) PETN as one embodiment of the present application.

FIG. 8 shows solid DNT residue testing on glove. The gloved finger was “finger-printed” successively onto the oligomer dodecyl-functionalized SiNC coated filter paper up to four times.

FIG. 9 shows solid DNT residue testing onto oligomer dodecyl-functionalized SiNC coated filter paper by (A) cotton swab tips having different amounts of DNT, DNT residue left after visibly brushing off 0.5 mg DNT from a (B) plastic tray and a (C) cotton fabric, respectively

FIG. 10 shows images of (A) a filter paper impregnated with oligomer dodecyl-functionalized silicon nanocrystals as a representative embodiment of the present application, (B) a gloved finger with trace amounts of solid TNT, (C) application of solid TNT to the impregnated filter paper, and (D) observed quenching of fluorescent filter paper after contact with solid TNT (see reflection on UV-lamp).

FIG. 11 shows concentration spot tests of nitroaromatics NB, MNT, and DNT at concentrations of (A) 0.25, 5 and 25 mM and (B) 1, 5, 12.5, 25, 50 and 75 μM of each compound on filter paper impregnated with exemplary fluorescent monolayer dodecyl SiNCs of the present application.

FIG. 12 shows concentration spot tests of nitroaromatics NB, MNT, and DNT at concentrations of (A) 0.25, 5 and 25 mM and (B) 1, 5, 12.5, 25, 50 and 75 μM of each compound on filter paper impregnated with exemplary fluorescent polystyrene SiNCs of the present application.

FIG. 13 shows concentration spot tests of nitroaromatic DNT at concentrations of 0.005, 0.25 and 25 on exemplary pentanoic acid SiNCs esterified filter paper of the present application.

### DETAILED DESCRIPTION

### I. Definitions

Unless otherwise indicated, the definitions and embodiments described in this and other sections are intended to be applicable to all embodiments and aspects of the application herein described for which they are suitable as would be understood by a person skilled in the art.

As used in this application, the singular forms “a”, “an” and “the” include plural references unless the content clearly dictates otherwise. For example, an embodiment including “a functionalized-SiNC” should be understood to present certain aspects with one type of functionalized SiNC, or two or more additional types of functionalized SiNCs.

In embodiments comprising an “additional” or “second” component, such as an additional or second functionalized SiNC, the second component as used herein is chemically different from the other components or first component. A “third” component is different from the other, first, and second components, and further enumerated or “additional” components are similarly different.

The term “suitable” as used herein means that the selection of the particular compound or conditions would depend on the specific synthetic manipulation to be performed, and the identity of the molecule(s) to be transformed, but the selection would be well within the skill of a person trained in the art. All process/method steps described herein are to be conducted under conditions sufficient to provide the product shown. A person skilled in the art would understand that all reaction conditions, including, for example, reaction solvent, reaction time, reaction temperature, reaction pressure, reactant ratio and whether or not the reaction should be performed under an anhydrous or inert atmosphere, can be varied to optimize the yield of the desired product and it is within their skill to do so.

In understanding the scope of the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The term “nitro-containing compounds” as used herein means a chemical compound comprising one or more nitro “—NO₂” functional groups, wherein at least one of the nitro groups interacts with the functionalized SiNCs of the present application and the interaction results in a detectable quenching of the fluorescence of the functionalized SiNCs. In an embodiment, the nitro-containing compound is a nitroaromatic, a nitroamine or a nitrate ester. In a further embodiment, the nitro-containing compound is an explosive. In yet another embodiment, the nitro-containing compound is mononitrotoluene (MNT), nitrobenzene (NB), dinitrotoluene (DNT), trinitrotoluene (TNT), cyclotrimethylenetrinitramine (RDX) or pentaerythritol tetranitrate (PETN), or a mixture thereof.

The term “alkyl” as used herein refers to straight or branched chain alkyl groups.

The term “alkanoic acid” as used herein refers to straight or branched chain alkyl carboxylic acid groups.

The term “alkyl-functionalized” as used herein refers to the chemical modification of a SiNC surface by incorporation of alkyl groups. For example, Si—H bonds on a SiNC are functionalized with alkyl groups by conversion to Si-Alkyl bonds.

The term “oligomer” as used herein refers to a substantially cross-linked multilayer of a functional group on a surface, such as the surface of a SiNC.

The term “monolayer” as used herein refers to a substantially single layer of a functional group on a surface, such as the surface of a SiNC.

The term “polystyrene-functionalized” as used herein refers to the chemical modification of a SiNC surface by incorporation of polystyrene groups. For example, Si—H bonds on a SiNC are functionalized with polystyrene groups by conversion to Si-polystyrene bonds.

The term “alkanoic acid-functionalized” as used herein refers to the chemical modification of a SiNC surface by incorporation of alkanoic acid groups. For example Si—H bonds on a SiNC are functionalized with alkanoic acid groups by conversion to Si-alkanoic acid bonds.

The term “amine” as used herein refers to a functional group comprising at least one NR′R″ group, wherein R′ and R″ are independently selected from H and C₁₋₁₀alkyl and includes, for example, a directly attached amine, an alkyl amine or an aromatic amine.

The term “amine-functionalized” as used herein refers to the chemical modification of a SiNC surface by incorporation of a functional group comprising at least one amine. For example Si—H bonds on a SiNC are functionalized with amine groups by conversion to Si-amine acid bonds.

The term “oligonucleotide” as used herein refers to short, single-stranded deoxyribonucleic acid or ribonucleic acid molecules.

The term “oligonucleotide-functionalized” as used herein refers to the chemical modification of a SiNC surface by incorporation of oligonucleotide groups. For example Si—H bonds on a SiNC are functionalized with oligonucleotide groups by conversion to Si— oligonucleotide bonds.

The term “paper” or “paper-based material” as used herein refers to a commodity of thin material produced by the amalgamation of fibers, typically plant fibers composed of cellulose, which are subsequently held together by hydrogen bonding. While the fibers used are usually natural in origin, a wide variety of synthetic fibers, such as polypropylene and polyethylene, may be incorporated into paper as a way of imparting desirable physical properties. The most common source of these kinds of fibers is wood pulp from pulpwood trees. Other plant fiber materials, including those of cotton, hemp, linen and rice, may also be used. The paper may be hydrophilic or hydrophobic, may have a surface coating, may incorporate fillers that provide desirable physical properties and may be previously modified prior to coating with the ink jet deposited sol-gel materials, by, for example, precoating with a hydrophilic, hydrophobic or charged polymer layer of organic or inorganic origin.

The term “sample(s)” as used herein means refers to any material that one wishes to assay using the detector of the application. The sample may be from any source, for example, any biological (for example human or animal), environmental (for example water or soil) or natural (for example plants) source, or from any manufactured or synthetic source (for example, clothing, electronic equipment, luggage, foods or drinks). The sample may be a liquid, solid or gas. The sample is one that comprises or is suspected of comprising one or more nitro-containing compounds.

The term “control” as used herein means a result obtained under identical conditions that are used for a test result, except for an absence of a parameter of interest or a parameter to be studied. In one embodiment of the present application, a control sample is a sample that is known to not contain nitro-containing compounds.

The term “luminescent” or “luminescence” as used herein refers to a material's property to emit light.

The term “photoluminescent” or “photoluminescence” as used herein refers a material's property to emit light upon application of energy from a light source.

The term “fluorescent” or “fluorescence” as used herein refers a material's property to emit light upon application of energy from a ultra violet (UV) light source.

### II. Detectors

Nitroaromatic, nitroamine and nitrate ester compounds were detected by observing their effect on the photoluminescence of functionalized SiNC's. A paper detector was developed and used to successfully detect solution, solid and vapor phase nitro-containing compounds through visualization of fluorescent quenching under UV light. The present detector, and corresponding methods of use, are portable, rapid and straightforward, and therefore are useful for on-site detection of nitro-containing compounds, such as nitro-containing explosives.

Accordingly, the present application includes a detector for nitro-containing compounds comprising functionalized silicon nanocrystals (SiNCs) supported on a substrate.

In an embodiment, the functionalized SiNCs are alkyl-, alkanoic acid-, amine-, oligonucleotide- or aromatic polymer-functionalized SiNCs. In a further embodiment, the functionalized SiNCs are selected from oligomer C₄-C₂₄alkyl-functionalized SiNCs, monolayer C₄-C₂₄alkyl-functionalized SiNCs, polystyrene-functionalized SiNCs and C₁-C₁₀alkanoic acid-functionalized SiNCs.

In an embodiment, the alkyl-functionalized SiNCs are functionalized with a C₈-C₂₀alkyl, C₁₀-C₁₄alkyl, or a C₁₂alkyl (dodecyl) group. In an embodiment the alkyl-functionalized SiNCs comprise oligomermized alkyl groups or a monomer layer of the alkyl groups. In an embodiment, the alkyl-functionalized SiNCs comprise a monomer layer of the alkyl groups.

In another embodiment, the functionalized SiNCs are polystyrene-functionalized SiNCs.

In a further embodiment, the C₁-C₁₀alkanoic acid-functionalized SiNCs are pentanoic acid-functionalized SiNCs.

In an embodiment, the SiNCs are oxide-embedded SiNCs. In a further embodiment, the oxide embedded SiNCs are obtained from the thermally induced disproportionation of hydrogen silsesquioxane (HSQ), for example as described in Hessel et al.²¹

In a further embodiment, the oxide-embedded SiNCs are alkyl-functionalized by etching with HF to provides red-emitting, hydride terminated SiNCs which are immediately functionalized by:

(a) reaction with a C₄-C₂₄alkene under thermal hydrosilylation, for example as described in Hessel et al.²¹ In an embodiment, these thermal hydrosilylation conditions result in a surface of oligomer alkyl-terminated SiNCs. Without wishing to be limited by theory, it has been proposed that radical reactions can occur which causes additional alkyl groups to bond to the alkyl groups attached to the surface of the SiNCs. This results in oligomerization and cross-linking of the surface alkyl groups; or
(b) azobisisobutyronitrile (AIBN) radical initiated reaction with a C₄-C₂₄alkene to provide monolayer C₄-C₂₄alkyl-functionalized SiNCs.

In a further embodiment, the oxide-embedded SiNCs are polystyrene-functionalized by etching with HF to provides red-emitting, hydride terminated SiNCs which are immediately polystyrene-functionalized by reaction with a styrene under thermal hydrosilylation, for example as described in Yang et al.²⁸

In a further embodiment, the oxide embedded SiNCs are C₁-C₁₀alkanoic acid functionalized by etching with HF to provide red-emitting, hydride terminated SiNCs which are immediately C₁-C₁₀alkanoic acid functionalized by reaction with a C₁-C₁₀alkanoic acid, for example as described by Clark et al. or by a radical initiator.²⁹

It is an embodiment of the present application that the substrate is any material upon which the functionalized SiNC's are supported or retained for the purpose of detecting nitro-containing compounds. In an embodiment, the functionalized SiNCs are supported by impregnation into the substrate and/or by adsorption onto the substrate's surface. In a further embodiment, the substrate is paper or paper-based material.

In an embodiment, the detector is saturated or comprises the maximum amount of the functionalized SiNCs that can be supported on the substrate. In a further embodiment, the functionalized SiNCs are applied to the substrate by dip-coating, for example, by immersing the substrate into a solution comprising the functionalized SiNCs. In an embodiment, the solution for dip-coating comprises about 0.1 mg/mL to about 10 mg/mL of the functionalized SiNCs. In a further embodiment, the substrate is immersed in the solution comprising the functionalized SiNCs for about 1 minute to about an hour or about 5 minutes to about 30 minutes.

### III. Methods

The present application also includes a method for detecting the presence of nitro-containing compounds in a sample comprising:

(a) exposing functionalized SiNCs to a sample suspected of comprising one or more nitro-containing compounds;

(b) observing the photoluminescence of the functionalized or polystyrene functionalized SiNCs in the presence and absence of the sample; wherein a decrease in photoluminescence of the functionalized SiNCs in the presence of the sample compared to in the absence of the sample indicates the presence of nitro-containing compounds in the sample.

In an embodiment, the functionalized SiNCs are alkyl-, alkanoic acid-, amine-, oligonucleotide- or aromatic polymer-functionalized SiNCs. In a further embodiment, the functionalized SiNCs are selected from oligomer C₄-C₂₄alkyl-functionalized SiNCs, monolayer C₄-C₂₄alkyl-functionalized SiNCs, polystyrene-functionalized SiNCs and C₁-C₁₀alkanoic acid-functionalized SiNCs

In an embodiment, the alkyl-functionalized SiNCs are functionalized with a C₈-C₂₀alkyl, C₁₀-C₁₄alkyl, or a C₁₂alkyl (dodecyl) group. In an embodiment the alkyl-functionalized SiNCs comprise oligomermized alkyl groups or a monomer layer of the alkyl groups. In an embodiment, the alkyl-functionalized SiNCs comprise a monomer layer of the alkyl groups.

In another embodiment, the functionalized SiNCs are polystyrene-functionalized SiNCs.

In a further embodiment, the C₁-C₁₀alkanoic acid-functionalized SiNCs are pentanoic acid-functionalized SiNCs.

In an embodiment, the SiNCs are oxide-embedded SiNCs. In a further embodiment, the oxide embedded SiNCs are obtained from the thermally induced disproportionation of hydrogen silsesquioxane (HSQ), for example as described in Hessel et al.²¹

In a further embodiment, the oxide-embedded SiNCs are alkyl-functionalized by etching with HF to provides red-emitting, hydride terminated SiNCs which are immediately functionalized by:

(a) reaction with a C₄-C₂₄alkene under thermal hydrosilylation, for example as described in Hessel et al.²¹ In an embodiment, these thermal hydrosilylation conditions result in a surface of oligomer alkyl-terminated SiNCs. Without wishing to be limited by theory, it has been proposed that radical reactions can occur which causes additional alkyl groups to bond to the alkyl groups attached to the surface of the SiNCs. This results in oligomerization and cross-linking of the surface alkyl groups; or
(b) azobisisobutyronitrile (AIBN) radical initiated reaction with a C₄-C₂₄alkene (to provide monolayer C₄-C₂₄alkyl-functionalized SiNCs).

In a further embodiment, the oxide-embedded SiNCs are polystyrene-functionalized by etching with HF to provides red-emitting, hydride terminated SiNCs which are immediately polystyrene-functionalized by reaction with a styrene under thermal hydrosilylation, for example as described in Yang et al.²⁸

In a further embodiment, the oxide embedded SiNCs are C₄-C₂₄alkanoic acid functionalized by etching with HF to provide red-emitting, hydride terminated SiNCs which are immediately C₁-C₁₀alkanoic acid functionalized by reaction with a C₁-C₁₀alkanoic acid, for example as described by Clark et al. or by a radical initiator.²⁹

In a further embodiment, the functionalized SiNCs are comprised in a detector of the present application, for example as defined in any one of the embodiments recited in the above section.

When the functionalized SiNCs are comprised in a detector, it is an embodiment that the functionalized SiNCs are exposed to the sample by direct contact. In an embodiment, the detector is immersed in a liquid sample or the liquid sample is drop coated, for example with a pipette or needle, on to the detector. In another embodiment, a solid sample is simply applied to the detector, for example with an applicator or by simply touching the detector to the sample. In another embodiment, a gaseous sample is applied to the detector by exposing the detector to the gas.

In a further embodiment, the C₄-C₂₄alkyl-functionalized SiNCs are in solution. In a further embodiment, the solution comprises the C₄-C₂₄alkyl-functionalized SiNCs and one or more solvents. In another embodiment, the one or more solvents are selected from any non-polar solvent in which the SiNCs are substantially soluble. Examples of solvents include, but are not limited to toluene, pentane, diethylether, cyclohexane, and chloroform. In a further embodiment, C₄-C₂₄alkyl-functionalized SiNCs are present in the solution at a concentration of about 0.1 mg/mL to about 5 mg/mL.

In a further embodiment, the polystyrene functionalized SiNCs are in solution. In a further embodiment, the solution comprises the polystyrene functionalized SiNCs and one or more solvents. In another embodiment the one or more solvents are selected from any non-polar solvent in which the SiNCs are substantially soluble including toluene, xylene, cyclohexane, and chloroform.

In a further embodiment the C₁-C₁₀alkanoic acid functionalized SiNCs are in solution. In a further embodiment the solution comprises the C₁-C₁₀alkanoic functionalized SiNCs and one or more solvents. In another embodiment the one or more solvents are selected from any polar solvent in which the SiNCs are substantially soluble including ethanol, water, and methanol.

When the functionalized SiNCs are comprised in a solution, it is an embodiment that the functionalized SiNCs are exposed to the sample by adding the sample to the solution.

In an embodiment, the photoluminescence is fluorescence. In a further embodiment, the fluorescence is observed by exposing the functionalized SiNCs to ultraviolet radiation and observing or measuring the resulting fluorescence of the functionalized SiNCs.

The present application also includes a use of functionalized SiNCs to detect nitro-containing compounds. In an embodiment, the functionalized SiNCs are alkyl-, alkanoic acid-, amine-, oligonucleotide- or aromatic polymer-functionalized SiNCs. In a further embodiment, the functionalized SiNCs are selected from oligomer C₄-C₂₄alkyl-functionalized SiNCs, monolayer C₄-C₂₄alkyl-functionalized SiNCs, polystyrene-functionalized SiNCs and C₁-C₁₀alkanoic acid-functionalized SiNCs.

### EXAMPLES

### Chemicals/Reagents and Materials

Hydrogen silsesquioxane (HSQ, trade name Fox-17, sold commercially as a solution in methyl isobutyl ketone) was purchased from Dow Corning Corporation (Midland, Mich.). Hydrofluoric acid (HF, 49% aqueous solution) was purchased from J.T. Baker. Reagent grade methanol, ethanol, toluene, 1-dodecene (95%), 2,4-dinitrotoluene (DNT), mononitrotoluene (MNT), styrene (99%), 4-penetanoic acid (>98%), azobisisobutyronitrile (AIBN) N,N′-dicyclohexylcarbodiimide, and 4-dimethylaminopyridine were purchased from Sigma Aldrich. Nitrobenzene (99%) was received from Alfa Aesar. 2,4,6-trinitrotoluene (TNT), pentaerythritol tetranitrate (PETN), and cyclotrimethylenetrinitramine (RDX) were synthesized using established literature procedures.²⁰

### Example 1

### Preparation of Hydride-Terminated Si Nanocrystals

A composite comprising SiNCs embedded within a SiO₂-like matrix was prepared via the thermally induced disproportionation of HSQ as described previously.²¹ Briefly, solid HSQ was placed in a quartz reaction boat and heated at 1100° C. in a tube furnace for 1 hour under reducing conditions (i.e., 95% Ar/5% H₂). This procedure yields SiNCs (diameter ca. 3.7 nm) within a protective oxide. After cooling to room temperature, the composite was crushed using an agate mortar and pestle to form a fine brown powder. Additional grinding was performed upon shaking with high-purity silica beads with a Burrell Wrist Action Shaker for 12 hours. The resulting SiNC/SiO₂ composite was chemically etched to liberate hydride-terminated SiNCs. 0.4 g of ground composite powder was transferred into a polypropylene beaker with a stir bar. 5 mL of water and 5 mL of ethanol were added to the beaker with mechanical stirring. 5 mL of 49% HF solution (Caution! HF must be handled with extreme care) was then slowly added to the beaker and the mixture was stirred for 1 h. The hydride-terminated SiNCs were extracted from the aqueous layer into ca. 30 ml (i.e., 3×10 ml) of toluene. The cloudy yellow SiNC toluene suspension was transferred into test tubes and centrifuged at 3000 rpm to isolate the SiNCs for immediate dodecyl functionalization (vide infra).

### Example 2

### Synthesis of Oligomer Dodecyl-Functionalized Silicon Nanocrystals

The toluene supernatant from the SiNC toluene suspension prepared in Example 1 was decanted and hydride-terminated SiNCs were immediately dispersed in ca. 30 mL dodecene and transferred to a flame dried Schlenk flask that was equipped with a magnetic stir bar. The flask was attached to a Schlenk line and evacuated and backfilled with argon three times to remove air. The reaction mixture was heated to 190° C. and stirred for 12 hours to yield a transparent orange/yellow solution. The resulting solution was cooled to room temperature and mixed with 105 mL of a 1:1 methanol:ethanol mixture and placed in a high-speed centrifuge at 14000 rpm for 0.5 h. The supernatant was decanted and 10 mL of toluene was added to redisperse the particles. 35 mL of 1:1 methanol:ethanol solution was then added and the centrifugation/decanting/redispersion procedure was repeated twice. The purified particles were finally redispersed in toluene (10 mL), filtered through a 0.45 μm PTFE syringe filter, and stored in vials under ambient conditions for future use.

### Example 3

### Synthesis of Monolayer Dodecyl Functionalized Silicon Nanocrystals

The toluene supernatant from the SiNC toluene suspension prepared in Example 1 was decanted and hydride-terminated SiNCs were immediately dispersed in ca. 20 mL toluene, 4 mL of 1-dodecene, and 10 mg of AIBN and transferred to a flame dried Schlenk flask that was equipped with a magnetic stir bar. The flask was attached to a Schlenk line and evacuated and backfilled with argon three times to remove air. The reaction mixture was heated to 60° C. and stirred for 12 hours to yield a transparent orange/yellow solution. The resulting solution was cooled to room temperature and mixed with 105 mL of a 1:1 methanol:ethanol mixture and placed in a high-speed centrifuge at 14000 rpm for 0.5 h. The supernatant was decanted and 10 mL of toluene was added to redisperse the particles. 35 mL of 1:1 methanol:ethanol solution was then added and the centrifugation/decanting/redispersion procedure was repeated twice. The purified particles were finally redispersed in toluene (10 mL), filtered through a 0.45 μm PTFE syringe filter, and stored in vials under ambient conditions for future use.

### Example 4

### Synthesis of Polystyrene Functionalized Silicon Nanocrystals

The toluene supernatant from the SiNC toluene suspension prepared in Example 1 was decanted and hydride-terminated SiNCs were immediately dispersed in ca. 6 mL toluene and 6 mL of styrene transferred to a flame dried Schlenk flask that was equipped with a magnetic stir bar. The flask was attached to a Schlenk line and evacuated and backfilled with argon three times to remove air. The reaction mixture was heated to 110° C. and stirred for 15 hours to yield a transparent orange solution. The resulting solution was cooled to room temperature and was dispensed into 4 test tubes and 10 mL of ethanol was added yielding a cloudy light yellow dispersion. The test tubes were subjected to centrifugation at 3000 rpm for 10 min. The supernatant was then decanted and the resulting precipitate was redispersed in 5 mL of toluene and and was sonicated for 0.5 h and reprecipitated by addition of ethanol. The dissolution/decanting/redispersion procedure was repeated twice. The purified particles were finally redispersed in toluene (10 mL), filtered through a 0.45 μm PTFE syringe filter, dried under vacuum for 12 h and stored in vials under ambient conditions for future use.

### Example 5

### Synthesis of Pentanoic Acid-Functionalized Silicon Nanocrystals

The toluene supernatant from the SiNC toluene suspension prepared in Example 1 was decanted and hydride-terminated SiNCs were immediately dispersed in ca. 20 mL dry toluene and transferred to a flame dried Schlenk flask that was equipped with a magnetic stir bar and, 2 mL of 4-pentanoic acid and 10 mg of AIBN. The flask was attached to a Schlenk line and evacuated and backfilled with argon three times to remove air. The reaction mixture was heated to 65° C. and stirred for 12 hours to yield a transparent orange/yellow precipitate. The resulting mixture was cooled to room temperature and the precipitate was isolated by centrifugation at 14 000 rpm for 20 min. The clear supernantant was decanted and the precipitate was re-dispersed in toluene. The centrifugation/decanting/dispersion process was repeated twice. The final precipitate was dried under N₂ to yield a yellow solid and stored in a vial for future use.

### Example 6

### Material Characterization and Instrumentation

Fourier Transform Infrared Spectroscopy (FT-IR) of functionalized SiNCs was performed using a Nicolet Magna 750 IR spectrophotometer by drop coating a toluene dispersion of SiNCs. Transmission Electron Microscopy (TEM) analysis was performed using a JEOL-2010 (LaB₆ filament) electron microscope with an accelerating voltage of 200 keV. TEM samples were prepared by drop casting a toluene solution of SiNCs onto a 200 μm mesh carbon coated copper grid and allowing the solvent to evaporate under vacuum prior to imaging. Size information was obtained by counting no fewer than 200 particles using Image J program. Photoluminescence (PL) spectra were acquired using a Cary Eclipse spectrophotometer (λₑₓ=350 nm). All solution-based quenching studies were performed using toluene solutions of functionalized SiNCs (1 mg/mL).

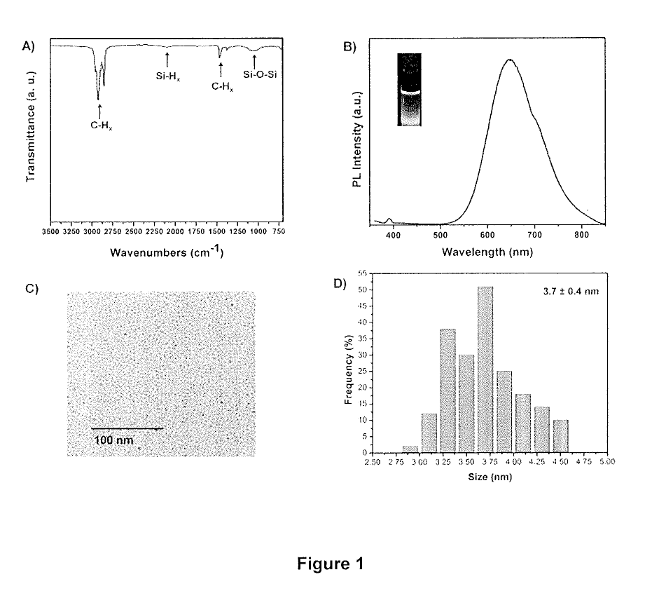

Material characterization of the exemplary oligomer dodecyl-functionalized SiNCs is summarized in FIG. 1. The FTIR spectrum (FIG. 1A) shows features characteristic of alkyl surfaces at 2920 cm⁻¹ (C—H stretching) and 1450 cm⁻¹ (—C—H bending) consistent with dodecyl functionalization.²² Features observed at 2110 cm⁻¹ and 1050 cm⁻¹ indicate SiHₓ and Si—O—Si functionalities, respectively, remain following functionalization. The PL spectrum of the dodecyl-functionalized SiNCs in toluene (FIG. 1B) shows a peak intensity maximum at 643 nm. Morphology was evaluated using transmission electron microscopy (FIG. 1C-D) which indicates the particles are pseudospherical with an average diameter of 3.7±0.4 nm.

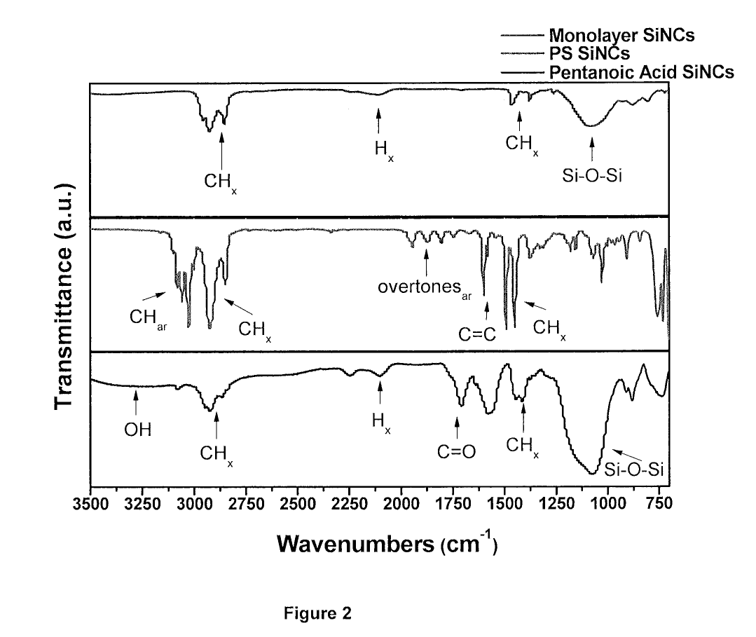

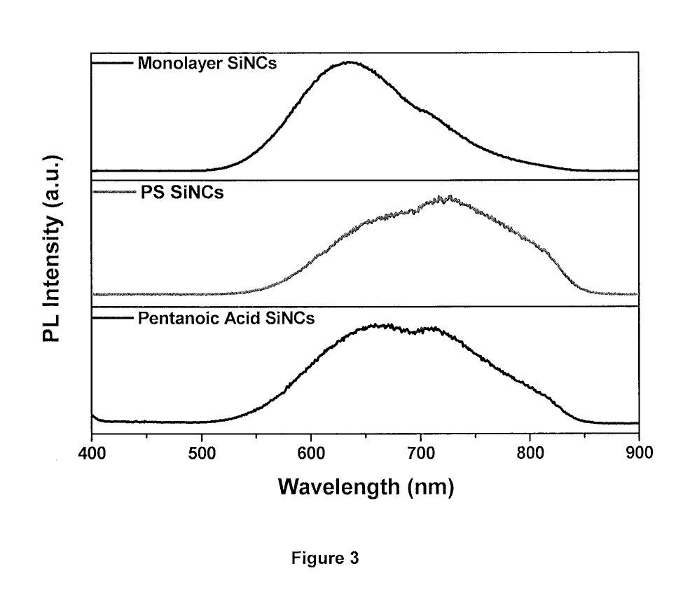

FTIR material characterization of monolayer dodecyl-, polystyrene- and pentanoic acid-functionalized SiNCs are summarized in FIG. 2. The monolayer SiNCs (FIG. 2, top scan) show characteristic stretches occurring at 2920 cm⁻¹ (C—H stretching) and 1400-1450 cm⁻¹ (Si—CH₂ scissoring), consistent with the oligomer dodecyl-functionalization described above.²² Features observed at 2110 cm⁻¹ and 1050 cm⁻¹ indicate SiHₓ and Si—O—Si functionalities, respectively, remain following functionalization. The PL spectrum of the monolayer dodecyl-functionalized SiNCs in toluene (FIG. 3, top) shows a peak intensity maximum at 630 nm.

The polystyrene functionalized SiNCs FTIR spectra (FIG. 2, middle) shows strong peaks consistent with polystyrene; 3000-3150 cm⁻¹ (phenyl C—H), 2850-3000 cm⁻¹ (aliphatic polymer backbone), 1800-1950 cm⁻¹ (phenyl overtones), and 1601 cm⁻¹ (phenyl ring C═C).²⁸ Si—CH₂ scissoring peaks at 1400-1450 cm⁻¹ are overshadowed by the intense peaks attributed to phenyl group C═C stretching and aliphatic C—Hₓ bending, but due to the absence of ˜1070 cm⁻¹ Si—O—Si and ˜2100 cm⁻¹ Si—Hₓ peaks it can be concluded the SiNCs are fully functionalized. The PL spectrum of the polystyrene-functionalized SiNCs in toluene (FIG. 3, middle) shows a peak intensity maximum at 742 nm.

The FTIR spectra of the pentanoic acid-functionalized particles (FIG. 2, bottom) showed characteristic carboxylic acid peaks at 1700 cm⁻¹ (C═O) and ˜3300 cm⁻¹ (—OH), as well as alkyl-terminated features at 2930 cm⁻¹ (C—H stretching) and 1400-1450 cm′ (Si—CH₂ scissoring), which agrees with previous observations of pentanoic acid functionalized SiNCs.²⁹ The PL spectrum of the pentanoic acid-functionalized SiNCs in toluene (FIG. 3) shows a peak intensity maximum at 656 nm.

### Example 7

### Solution Phase PL Quenching Studies of Oligomer Dodecyl-Functionalized SiNCs

Stock solutions of NB, MNT, and DNT were prepared in toluene at appropriate concentrations. The working solutions were then stirred thoroughly prior to fluorescent measurements for a minimum of 5 minutes each. The solution samples were then transferred to a spectrophotometer quartz cuvette and fluorescent measurements were then taken at room temperature.

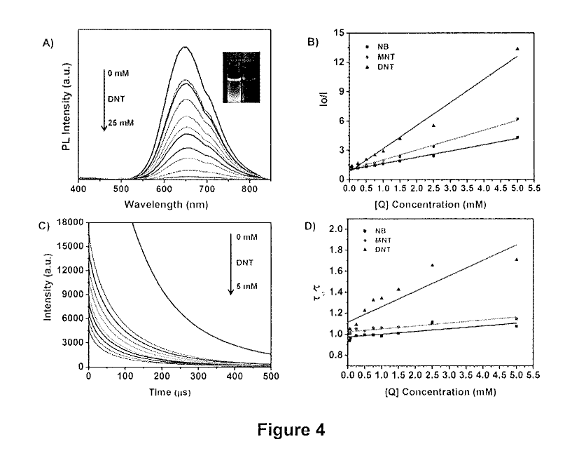

Upon addition of nitroaromatic compounds (i.e., NB, MNT, and DNT) to solutions of dodecyl functionalized SiNCs, fluorescence was effectively quenched. FIG. 4A shows titration curves of the fluorescence peak intensity of toluene solutions containing 1 mg/mL SiNCs as a function of DNT concentrations ranging from 0.05 to 25 mM. The degree of SiNC PL quenching was proportional to the concentration of DNT (i.e., higher the DNT concentration yields more efficient the quenching). In addition, no shift in PL maximum or any changes in the line shape of the PL spectrum resulted. Similar behaviour was observed in the titration curves for the NB and MNT compounds investigated.

To gain a more complete understanding of the quenching behaviour induced by NB, MNT, and DNT on dodecyl-functionalized SiNC PL data was evaluated using the Stern-Volmer equation:

Iₒ/I=Kₛᵥ[Q]+1

where Iₒ and I are the fluorescence intensity in the absence and presence of nitroaromatic compounds, respectively. [Q] is the nitroaromatic compound concentration, and Kₛᵥ is the fluorescence quenching constant. FIG. 4B shows a linear relationship of Iₒ/I vs. nitroaromatic compound (NB, MNT, DNT) concentration. In the range of 0.05-5 mM of NB, MNT, and DNT display linear behavior indicative of the quenching arising from a dynamic process such as an electron transfer.²³ Others have proposed based upon the correlation of reduction potentials in nitroaromatic compounds that fluorescence quenching of porous silicon and oxide terminated web-like aggregates of SiNCs proceeds via an electron transfer pathway.^{17,18,24} While not wishing to be limited by theory, it is believed the electron transfer occurs by way of transfer of an electron from the Si nanomaterial conduction band to vacant π* orbitals of the nitroaromatic compound resulting in photoluminescence quenching.^{18,25} If this is the case for the present systems, considering the known reduction potentials of NB, MNT, and DNT (i.e., −1.15 V, −1.19, and −0.9 V vs. NHE in acetonitrile, respectively),^{17,24} the PL quenching efficiency should decrease with redox potential. As such, DNT should be the most efficient quencher of the three tested here. The Kₛᵥ values determined from the analysis presented in FIG. 2 are 0.644 mM⁻¹, 1.01 mM⁻¹, and 2.36 mM⁻¹ for NB, MNT, and DNT, respectively. This trend supports the proposal that quenching is occurring via an electron transfer mechanism.

To further verify the quenching mechanism is a dynamic process, the PL lifetime of the SiNCs as a function for each of the nitroaromatic quenchers (i.e., NB, MNT, DNT) concentration in the range of 0.05-5 mM was studied. If the PL lifetime is independent of the quencher concentration, the quenching mechanism is static and is governed by the formation of a ground state nanoparticle-analyte complex.³¹ Alternatively, if the quenching process is dynamic there will be a decrease in the lifetime because of additional deactivation pathways (e.g., electron transfer) that will shorten the lifetime.³¹ For the present system, increasing the concentration of the nitroaromatic compound resulted in a decrease of lifetime decays (FIG. 4C). These results were then plotted as τₒ/τ vs. nitroaromatic compound (NB, MNT, DNT) concentration where τₒ and τ are the PL lifetimes in the absence and presence of nitroaromatic compounds, respectively (FIG. 4D). As expected, DNT was the most efficient lifetime quencher of all nitro compounds tested. These results further support the quenching mechanism is a dynamic process via electron transfer.

To determine the limit of detection (LOD) that PL quenching of functionalized SiNCs display for toluene solutions of NB, MNT and DNT, PL quenching arising from analyte concentrations of the range 0.05-5 mM was evaluated. The LOD for nitroaromatic compounds in toluene were determined following the 3σ IUPAC criteria and were determined to be 1.54 mM, 0.995 mM, and 0.341 mM (i.e., 184. 6, 136.5, and 62.1 ppm, respectively) for NB, MNT, and DNT, respectively.^{26, 27} Consistent with the electron transfer mechanism noted above, DNT displayed the most sensitive LOD while NB had the least sensitive. These solution LODs are sufficient for the practical usefulness of this SiNC detection system, although the system has also been extended to solid residue and vapor detection (vide infra).

### Example 8

### Solution Phase PL Quenching Studies of Polystyrene-Functionalized SiNCs

Stock solutions DNT were prepared in toluene at appropriate concentrations. The working solutions were then stirred thoroughly prior to fluorescent measurements for a minimum of 5 minutes each. The solution samples were then transferred to a spectrophotometer quartz cuvette and fluorescent measurements were then taken at room temperature.

### Example 9

### Oligomer Dodecyl-Functionalized SiNCs Paper Sensor for Visual Detection of Nitroaromatic Compounds

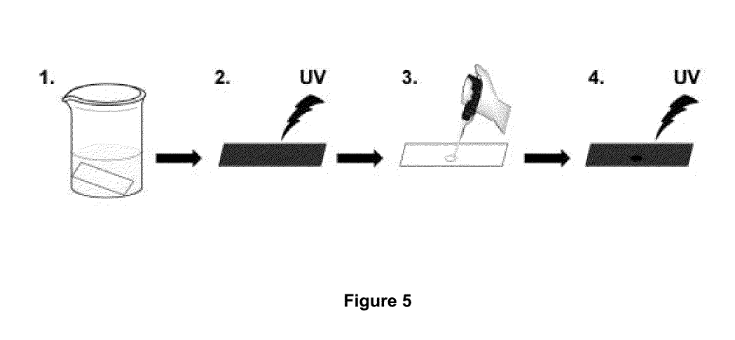

A piece of filter paper (Fisherbrand, qualitative P4) was cut into small rectangles and dipped into a beaker containing a 5 mg/mL solution of dodecyl functionalized SiNCs for 12 min. The filter paper was then removed and dried under N₂ for 2 min. This indicator paper displayed red orange fluorescence when exposed to a hand held UV lamp (λ=365 nm). To display the potential application as a fluorescent paper sensor, solutions of nitroaromatic compounds were spotted onto the paper directly by pipette, or “fingerprinted” with solid nitroaromatic compounds onto the paper. Finally the paper was imaged under the UV lamp (λ=365 nm) and photos were taken by a digital camera. This process is shown schematically in FIG. 5.

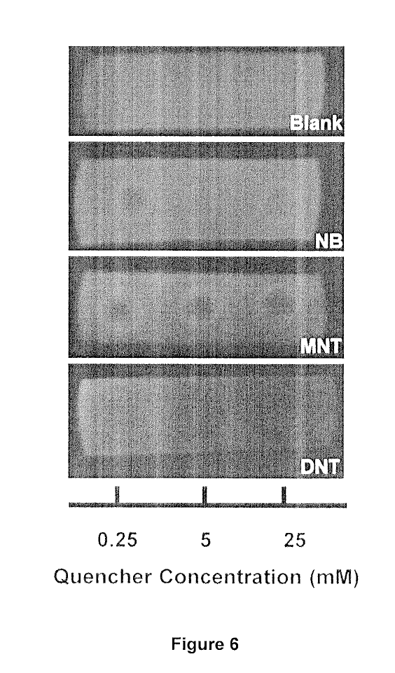

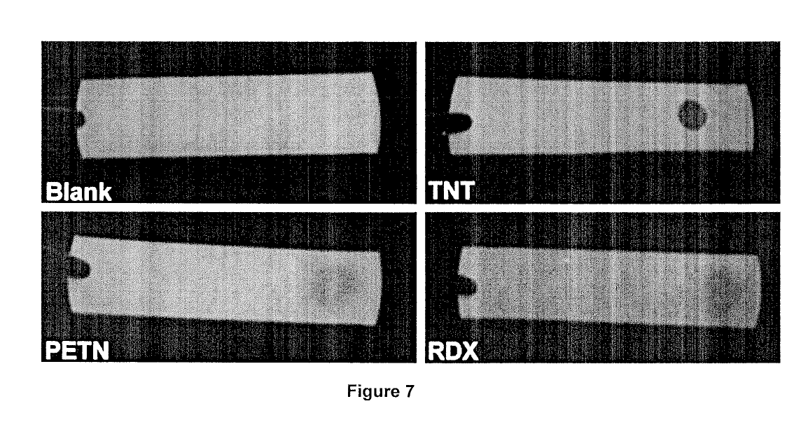

This filter paper impregnated with fluorescent SiNCs extends the potential utility of the present SiNC sensing motif. The paper displayed red-orange photoluminescence characteristic of the SiNC upon exposure to a standard handheld UV (λ=365 nm) lamp (FIG. 6). To test the sensitivity of this new detecting morphology 2 μL of stock solutions (0.25, 5 and 25 mM) of NB, MNT, and DNT were spotted onto the prepared paper. Photographs of the exposed papers are shown in FIG. 6. All concentrations tested resulted in complete quenching of the area spotted for every compound. The results indicate the filter paper is more effective at 0.25 and 5 mM concentration than solution phase measurement by the fluorimeter where complete quenching at these concentrations was not achieved. There was no visibly detectable difference in the quenched spots for all concentrations of NB and MNT. However, DNT displayed dramatic increase in the area surrounding the initial spot of the compound. As seen in solution, DNT is the most effective of the nitroaromatics tested. To further test the application of the filter paper, 25 μL of 0.01 mM solutions of explosives TNT, RDX, and PETN were spotted onto the filter paper, the fluorescence was rapidly and thoroughly quenched for all compounds (FIG. 7). This study showed the filter paper is not only sensitive to nitroaromatics, but also nitroamines and nitro esters as well, and therefore increasing the scope of such a sensor in real-world applications.

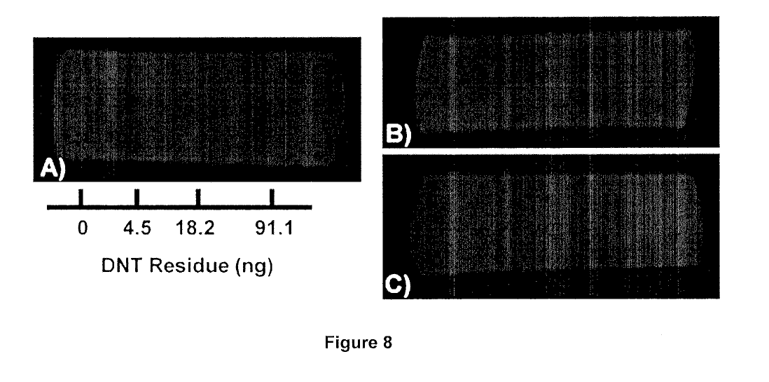

This same paper detector was also applied in the detection of chemical residues on surfaces or in vapors. Cotton swab residue studies were carried out by drop coating varying concentrations (0.0125, 0.05 and 0.25 mM) of DNT onto cotton swab tips. A blank swab was prepared by drop coating 2 μL of toluene onto a cotton swab and left to dry. All of the prepared swabs were then pressed onto the filter paper to observe if quenching of fluorescence occurs. These swabs were then left to air dry, resulting in residues of 4.5, 18.2 and 91.1 ng, respectively, of DNT on the swab. Quenching of fluorescence was observed with all but the lowest amount of DNT, therefore the present system can detect as little as 18 ng of DNT (FIG. 8A).

For solid residue studies, 0.5 mg of DNT was applied to cotton fabric or a plastic tray, brushed off, then the filter paper was rubbed onto the fabric, and observed under UV light. After visible removal of DNT from both surfaces, testing of the surfaces with the paper detector of the present application resulted in quenching of fluorescence (FIG. 8B-C)

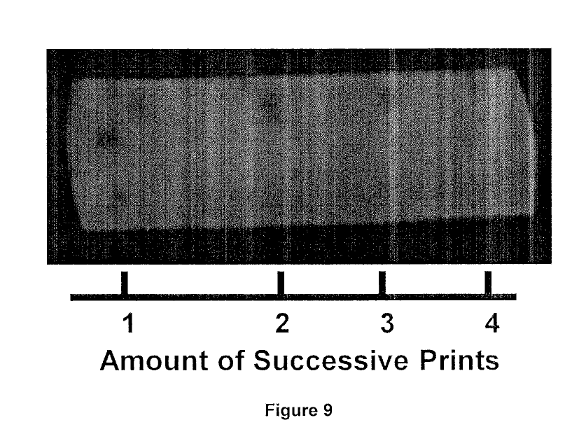

A similar procedure was followed to test solid residues on gloves. 0.5 mg of DNT was weighed in a plastic tray and then a gloved finger tapped onto the solid DNT sample. The excess solid was brushed off until no visible solid was present on the glove. The gloved finger was then pressed four times successively on the filter paper. The paper was then viewed under the UV lamp to determine if quenching was achieved. Pressing the finger onto the paper four successive times resulted in quenching (FIG. 9). Although the exact quantity of DNT residue on the glove decreased with successive printing, the signal to noise ratio between the first and last print remained unchanged.

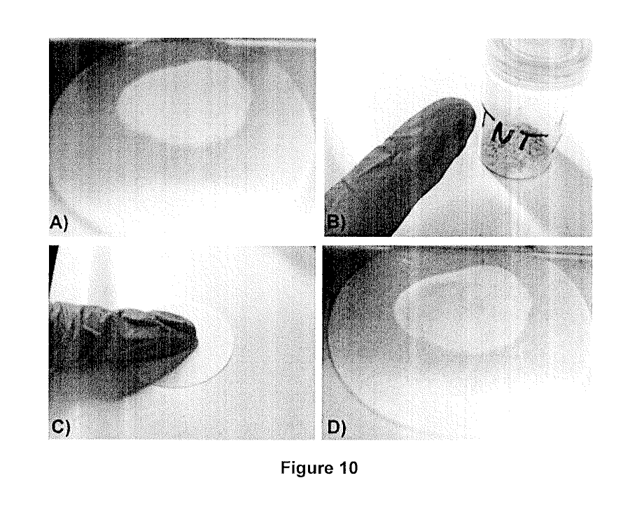

Solid TNT was similarly tested using the glove method, where the contaminated finger was placed on the fluorescent area of the detector paper, and the fluorescence was quenched where the fingerprint was imprinted (see FIG. 10).

Noteworthy is that control tests with a gloved finger, a bare finger and a finger of someone who recently smoked a cigarette provided no quenching. The ability of the exemplary filter paper sensor of the present application to detect explosive contamination residue which are not visibly present makes it a reliable and versatile detection system for real-world applications.

Vapor testing of NB was performed by placing the prepared sensor paper over the mouth of a bottle containing concentrated NB for 3 minutes. The resulting paper was then removed and imaged under a UV lamp. To check if the filter paper sensor was reusable, it was placed in a nitrogen stream after exposure to the NB vapours for 2 minutes (to evaporate the NB), then removed and imaged under a UV lamp. When the filter paper was exposed to NB vapors, complete quenching of the fluorescence was observed within 3 minutes and quenching was reversed upon exposure to a stream of flowing nitrogen.

The results reported herein indicate that the present paper sensor can detect solution, vapor, and solid phase nitro-containing compounds. The paper-based system may be best adapted as a reliable frontline screening method for on-site detection where rapid detection of explosives and related compounds would prove useful, such as landmines and airport and border security areas.

These results indicate the present paper motif can detect solution, vapor and solid phase nitroaromatic compounds. The paper-based system may be best adapted as a reliable frontline screening method for on-site detection where rapid detection of explosives and related

### Example 10

### Monolayer Dodecyl-Functionalized SiNCs Paper Sensor for Visual Detection of Nitroaromatic Compounds

To extend the application of SiNCs as sensors, monolayer protected dodecyl SiNCs were impregnanted onto paper based substrates. A piece of filter paper (Fisherbrand, qualitative P4) was cut into small rectangles and dipped into a beaker containing a 1 mg/mL solution of monolayer dodecyl-functionalized SiNCs for 12 min. The filter paper was then removed and dried under N₂ for 2 min. This indicator paper displayed red orange fluorescence when exposed to a hand held UV lamp (λ=365 nm).

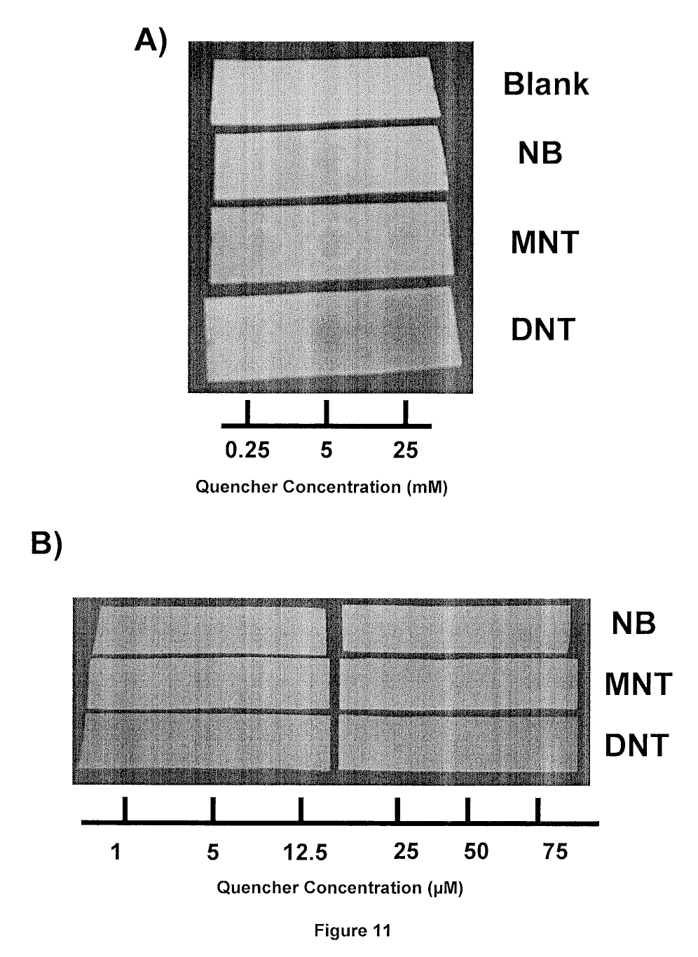

To test the sensitivity of the monolayer dodecyl SiNCs, 2 μL of stock solutions (0.25, 5 and 25 mM and 1, 5, 12.5, 25, 50, 75 μM) of NB, MNT, and DNT were spotted onto the prepared paper. Photographs of the exposed papers are shown in FIG. 11. It can be seen that the paper sensor is sensitive to all concentrations tested.

### Example 11

### Polystyrene SiNCs Paper Sensor for Visual Detection of Nitroaromatic Compounds

To extend the application of SiNCs as sensors, polystyrene functionalized SiNCs were impregnated onto paper based substrates. A piece of filter paper (Fisherbrand, qualitative P4) was cut into small rectangles and dipped into a beaker containing a 20 mg/mL solution of dodecyl functionalized SiNCs for 12 min. The filter paper was then removed and dried under N₂ for 2 min. This indicator paper displayed red orange fluorescence when exposed to a hand held UV lamp (λ=365 nm).

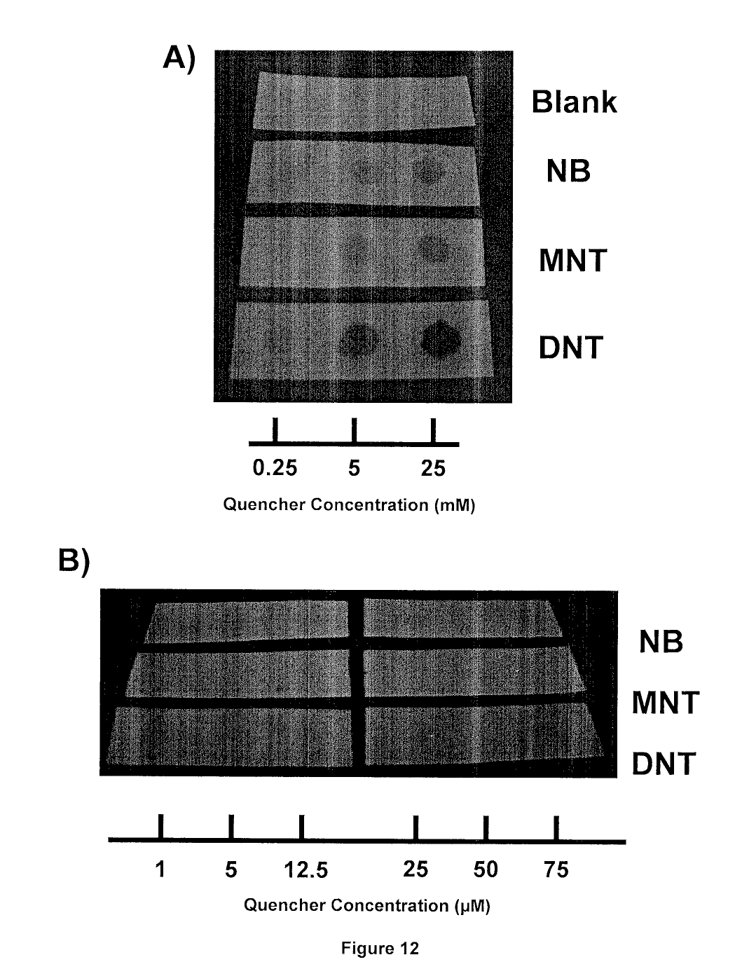

To test the sensitivity of the polystyrene-functionalized SiNCs, 2 μL of stock solutions (0.25, 5 and 25 mM and 1, 5, 12.5, 25, 50, 75 μM) of NB, MNT, and DNT were spotted onto the prepared paper (FIG. 12). The paper sensor was sensitive to all concentrations tested.

### Example 12

### Esterification of Pentanoic Acid-Functionalized SiNCs to Cellulose Filter Paper

The Steglich esterification of the SiNCs to the filter paper was carried out by first adding ˜20 mg pentanoic acid functionalized SiNCs (dispersed in dry toluene) to an oven dried tube flask with a magnetic stir bar.³⁰ Two pieces of oven dried 1.5 cm by 5 cm Fisherbrand P4 filter paper were then added to the flask and dry toluene was added until the filter paper was fully immersed in solution. The flask was put in an ice bath and stirred. N,N′-Dicyclohexylcarbodiimide (DDC) dissolved in dry toluene was added dropwise to the flask followed by slow addition of 4-dimethylaminopyridine (DMAP). The flask was kept in the ice bath for 10 minutes and then stirred overnight under Ar atmosphere. The filter paper pieces were removed and washed with toluene and ethanol and dried under vacuum to remove unreacted reagents and SiNCs.

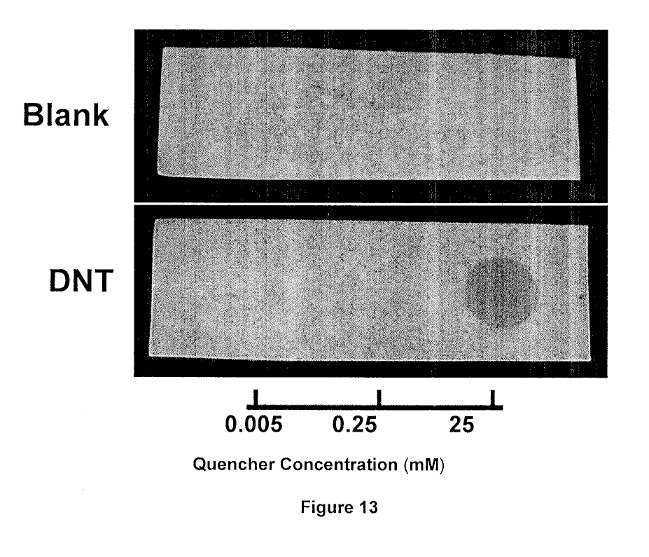

To test the sensitivity of the esterified SiNC paper, 2 μL of stock solutions 0.050, 0.25, 25 mM of DNT were spotted onto the prepared paper (FIG. 13). The paper sensor was sensitive to the concentrations of 0.25 and 25 mM DNT solutions.

While the present application has been described with reference to what are presently considered to be the preferred examples, it is to be understood that the application is not limited to the disclosed examples. To the contrary, the application is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

### FULL CITATIONS FOR DOCUMENTS REFERRED TO IN THE SPECIFICATION

¹ Balan, B.; Vijayakumar, C.; Tsuji, M.; Saeki, A.; Seki, S. J. Phys. Chem. B 2012, 116, 10371-10378.
² Germain, M. E.; Knapp, M. J. Chem. Soc. Rev. 2009, 38, 2543-2555.
³ Salinas, Y.; Martinez-Manez, R.; Marcos, M. D.; Sancenon, F.; Costero, A. N.; Parraad, M.; Salvador Gil, S. Chem. Soc. Rev. 2012, 41, 1261-1296.
⁴ Hakansson, K.; Coorey, R. V.; Zubarev, R. A.; Talrose, V. L.; Hakansson, P. J. Mass Spectrom. 2000, 35, 337-346.
⁵ Najarro, M.; Morris, M. E. D.; Staymates, M. E.; Fletcher, R.; Gillen, G. Analyst 2012, 137, 2614-2622.
⁶ Sylvia, J. M.; Janni, J. A.; Klein, J. D.; Spencer, K. M. Anal. Chem. 2000, 72, 5834-5840.
⁷ Luggar, R. D.; Farquharson, M. J.; Horrocks, J. A.; Lacey, R. J. J. X-Ray Spectrom. 1998, 27, 87-94.
⁸ Feng, J.; Li, Y.; Yang, M. Sensor Actuat. B 2010, 145, 438-443.
⁹ Yang, Y.; Wang, H.; Su, K.; Long, Y.; Peng, Z.; Li, N.; Liu, F. J. Mater. Chem. 2011, 21, 11895-11900.
¹⁰ Tu, R.; Liu, B.; Wang, Z.; Gao, D.; Wang, F.; Fang, Q.; Zhang, Z. Anal. Chem. 2008, 80, 3458-3465.
¹¹ Costa-Fernandez, J. M.; Pereiro, R.; Sanz-Medel, A. Trends Anal. Chem. 2006, 25, 207-218.
¹² Freeman, R.; Wilner, I. Chem. Soc. Rev. 2012, 41, 4067-4085.
¹³ Freeman, R.; Finder, T.; Bahshi, L.; Gill, R.; Willner, I. Adv. Mater. 2012, 24, 6416-6421.
¹⁴ Zhang, K.; Zhou, H.; Mei, Q.; Wang, S.; Guan, G.; Liu, R.; Zhang, J.; Zhang, Z. J. Am. Chem. Soc. 2011, 133, 8424-8427.
¹⁵ Ma, Y.; Li, H.; Peng, S.; Wang, L. Anal. Chem. 2012, 84, 8415-8421.
¹⁶ Derfus, A. M.; Chan, W. C. W.; Bhatia, S. N. Nano Lett. 2004, 4, 11-18.
¹⁷ Content, S.; Trogler, W. C.; Sailor, M. J. Chem. Eur. J. 2000, 6, 2205-2213.
¹⁸ Germanenko, I. N.; Li, S.; El-Shall, M. S. J. Phys. Chem. B 2001, 105, 59-66.
¹⁹ Garcia-Reyes, J. F.; Harper, J. D.; Salazar, G. A.; Charipar, N. A.; Ouyang, Z.; Cooks, R. G. Anal. Chem. 2011, 83, 1084-1092.
²⁰ Ledgard, J. The Preparatory Manual of Explosives, 3^{rd} ed.; USA, 2007.
²¹ Hessel, C. M.; Henderson, E. J.; Veinot, J. G. C. Chem. Mater. 2006, 18, 6139-6146.
²² Kelly, J. A.; Veinot, J. G. C. ACS Nano, 2010, 4, 4645-4656.
²³ Scaiano, J. C.; Laferrière, M.; Galian, R. E.; Maurel, V.; Billone, P. Phys. Stat. Sol. A 2006, 203, 1337-1343.
²⁴ Rehm, J. M.; McLendon, G. L.; Fauchet, P. M. J. Am. Chem. Soc. 1996, 118, 4490-4491.
²⁵ Bar, A. K.; Shanmugaraju, S.; Chib, K.; Mukherjee, P. S. Dalton Trans. 2011, 40, 2257-2267.
²⁶ Jin, W. J.; Fernandez-Arguelles, M. T.; Costa-Fernandez, J. M.; Pereiro, R.; Sanz-Medel, R. Chem. Commun. 2005, 883-885.
²⁷ Jin, W. J.; Costa-Fernandez, J. M.; Pereiro, R.; Sanz-Medel, A. Anal. Chim. Acta 2004, 522, 1-8.
²⁸ Yang, Z.; Dasog, M.; Dobbie, A. R.; Lockwood, R.; Zhi, Y.; Meldrum, A.; Veinot, J. G. C. Adv. Func. Mater. 2013, in press.
²⁹ Clark, R. J.; Dang, M. K. M.; Veinot, J. G. C. Langmuir, 2010, 26, 15657-15664.
³⁰ B. Neises, W. Steglich. Angew. Chem. Int. Ed., 1978, 17, 522-524.

1. A detector for nitro-containing compounds comprising functionalized silicon nanocrystals (SiNCs) supported on a substrate.

2. The detector of claim 1, wherein the functionalized SiNCs are alkyl-, alkanoic acid-, amine-, oligonucleotide- or aromatic polymer-functionalized SiNCs.

3. The detector of claim 1, wherein the functionalized SiNCs are selected from oligomer C₄-C₂₄alkyl-functionalized SiNCs, monolayer C₄-C₂₄alkyl-functionalized SiNCs, polystyrene-functionalized SiNCs and C₁-C₁₀alkanoic acid-functionalized SiNCs.

4. The detector of claim 1, comprising monolayer dodecyl-functionalized SiNCs.

5. The detector of claim 1, comprising pentanoic acid-functionalized SiNCs.

6. The detector of claim 1, comprising polystyrene-functionalized SiNCs.

7. The detector of claim 1, wherein the substrate is a paper substrate.

8. A method for detecting the presence of nitro-containing compounds in a sample comprising:
(a) exposing functionalized SiNCs to a sample suspected of comprising one or more nitro-containing compounds;
(b) observing the photoluminescence of the functionalized SiNCs in the presence and absence of the sample;
wherein a decrease in photoluminescence of the functionalized SiNCs in the presence of the sample compared to in the absence of the sample indicates the presence of nitro-containing compounds in the sample.

9. The method of claim 8, wherein the functionalized SiNCs are in solution.

10. The method of claim 8, wherein the functionalized SiNCs are supported on a substrate.

11. The method of claim 8, wherein the functionalized SiNCs are alkyl-, alkanoic acid-, amine-, oligonucleotide- or aromatic polymer-functionalized SiNCs.

12. The method of claim 8, wherein the functionalized SiNCs are selected from oligomer C₄-C₂₄alkyl-functionalized SiNCs, monolayer C₄-C₂₄alkyl-functionalized SiNCs, polystyrene-functionalized SiNCs and C₁-C₁₀alkanoic acid-functionalized SiNCs.

13. The method of claim 8, wherein the functionalized SiNCs are monolayer dodecyl-functionalized.

14. The method of claim 8, wherein the functionalized SiNCs are pentanoic acid-functionalized.

15. The method of claim 8, wherein the functionalized SiNCs are polystyrene-functionalized.

16. The method of claim 8, wherein the photoluminescence is fluorescence.

17. The method of claim 16, wherein the fluorescence is observed by exposing the functionalized SiNCs to ultraviolet radiation and observing or measuring the resulting fluorescence of the functionalized.

18. The method of claim 8, wherein the nitro-containing compound is a nitroaromatic, a nitroamine or a nitrate ester.

19. The method of claim 8, wherein the nitro-containing compound is an explosive.

20. The method of claim 19, wherein the nitro-containing compound is mononitrotoluene (MNT), nitrobenzene (NB), dinitrotoluene (DNT), trinitrotoluene (TNT), cyclotrimethylenetrinitramine (RDX) or pentaerythritol tetranitrate (PETN), or a mixture thereof.
